(19) United States
(12) Patent Application Publication
(10) Pub. No.: US 2015/0252734 A1
(43) Pub. Date: Sep. 10, 2015

(54) Lever Shifter Control Cable Assembly Having a Choke Return and a Force Enhancing Mechanism

(71) Applicant: Suprajit Engineering Ltd., Bangalore (IN)

(72) Inventors: Subba Narahari Rao, Bangalore (IN); Basavaraj Ukanal, Bangalore (IN); Mukund Rao, Bangalore (IN)

(73) Assignee: Suprajit Engineering Ltd., Bangalore (IN)

(21) Appl. No.: 14/691,046

(22) Filed: Apr. 20, 2015

Related U.S. Application Data
(63) Continuation-in-part of application No. 13/951,888, filed on Jul. 26, 2013, now Pat. No. 9,046,127.

(30) Foreign Application Priority Data
Oct. 17, 2012 (IN) 4338/CHE/2012
Jul. 10, 2014 (IN) 3429/CHE/2014

(51) Int. Cl. F02D 11/04; F02M 1/02; G05G 5/05; F16C 1/12

(52) U.S. Cl. CPC F02D 11/04; F16C 1/12; F02M 1/02; G05G 5/05

(57) ABSTRACT

The present invention provides an assembly for lever shifter cable control having a choke return and a force enhancing mechanism. The assembly includes a first housing and a second housing. The first housing comprises of a first lever shifter movably mounted between the two halves of the casing for pivotal movement about a pivot axis. The second housing comprises of a second lever shifter with a torsion spring having two ends, wherein the one end of torsion spring is designed to hook to the second housing and the other end of torsion spring is designed to hook against the stiffing wall of the second lever shifter. The second housing is further attached with a wave spring to impart the lever force and to eliminate a friction bend in the cable assembly.

### DESCRIPTION OF THE INVENTION

The following specification particularly describes the invention and the manner in which it is to be performed:

### FIELD OF THE INVENTION

The present invention relates to functional, mounting and control mechanism on engine functions such as throttle, power take-off and the like when the engines are used in products such as lawn movers, tillers, snowmobiles and similar equipments. The invention relates more specifically to an assembly for choke lever shifter having a choke return and a force enhancing mechanism to eliminate a friction bend in the cable assembly.

### BACKGROUND OF THE INVENTION

Lever control cables are mostly used in variety of applications in order to remotely control the various mechanism of a machine such as power take-off, throttles, brakes, chokes and the like. The use of lever shifter control cables are well known in the field of devices such as lawn mower, snow mobile, tiller and the like. The presence of these lever shifter control cables enables the users to control the device much easily and efficiently. There are various methods that exist for fitting these lever shifter control cables to the machines.

The ability to provide a control cable assembly as a snap-in unit has developed as a desired option. There are many prior arts existing that disclose a lever shifter cable assembly that operates using a housing which substantially encloses a detent mechanism to which a shiftable lever is attached. However, these systems have several limitations such as causing sound disturbance and inconvenience for the persons using the lever shifter control cable assembly. Typically, these systems do not provide facility for a choke return mechanism. Conventional systems do not facilitate for the elimination of friction bend in the cable assembly. The ability to give smooth functioning over a continuous operating range is restricted in case of the prior art due to the assembly limitations. Many of the already existing assembly create unwanted sound due to friction between metal parts especially while controlling the cable for various functions.

Hence there is a need of a choke return and a force enhancing mechanism that provides ease of assembly and eliminates the friction bend on to the cable assembly and provides reliability of a lever shifter function to the engine in application such as lawn mower, snow mobiles, tiller and others.

### SUMMARY OF THE INVENTION

According to an embodiment, present invention provides an assembly for lever shifter cable control. The assembly includes a casing which comprises of a two halves defining a chamber there in between, wherein the two halves are first housing and second housing. The first housing comprises of a first lever shifter movably mounted between the two halves of the casing for pivotal movement about a pivot axis, wherein the first lever shifter is configured for to and fro movement. The second housing comprises of a second lever shifter with a torsion spring having two ends, wherein the one end of torsion spring is designed to hook to the second housing and the other end of torsion spring is designed to hook against the stiffing wall of the second lever shifter. The second lever shifter radially spins when a thumb force is applied and returns back to the desired position due to action of the torsion spring.

In the preferred embodiment, the assembly has a roller-spring-sleeve unit operatively connected to the first lever shifter, the roller-spring-sleeve unit being housed in a receptacle in the casing for controlling the first lever shifter. Also four numbers of snap fit units each comprising a flat spring configured into a U-shaped nylon mold part have been inserted into left and right covers to retain the casing to the panel. An at least one cable assembly is mounted on an abutment lever, wherein the abutment lever is housed within the casing and coupled to the first lever shifter and second lever shifter. A control cable connected to the casing through the abutment through a hole in the casing.

In preferred embodiment of the present invention, the first lever shifter and the second lever shifter movably mounted between the two halves of the casing pivots on a cylindrical projection and radially spins with respect to an inner wall of the casing.

In the preferred embodiment of the present invention, the case has an inner wall, wherein the first lever shifter, the second lever shifter, the roller-spring-sleeve unit and the snap fit unit are configured to the inner wall.

In the preferred embodiment of the present invention, the torsion spring is composed of a spring steel material.

In the preferred embodiment of the present invention, the first lever shifter and the second lever shifter are made of different colour.

In the preferred embodiment of the present invention, the first lever shifter when operated the roller-spring-sleeve mechanism unit disengages from the groove and rides on the wall of lever shifter until stopping against a boundary of the wall.

In the preferred embodiment of the present invention, the first lever shifter further comprises a groove, wherein upon operating the first lever shifter the roller-spring-sleeve unit rides against a wall of the first lever shifter and the roller engages with the groove.

In the preferred embodiment of the present invention, the first lever is throttle lever shifter and the second lever shifter is choke lever shifter.

In the preferred embodiment of the present invention, the roller-spring-sleeve unit is connected to a lug coupled to an inner wall of the casing; the roller-spring-sleeve unit includes a compression spring, a sleeve and a roller. The compression spring coupled to the lug and positioned in a vertical orientation. The sleeve connected to the compression spring, wherein the sleeve has a dish shaped configuration and configured to match with the lug. The roller configured to be received by the sleeve.

According to another embodiment of the present invention, the second housing further comprises of an at least one wave spring, wherein the wave spring attached to the second housing aims to impart the second lever shifter force and to eliminate a friction bend in the cable assembly.

The present invention provides ease of assembly on to the panel and reliability of the shifter function to the engine very efficiently in applications like lawn mower, snow mobiles, tiller and other such devices.

### BRIEF DESCRIPTION OF THE DRAWINGS

Drawings here indicate one of the applications of the invention pertaining to throttle control cable assembly of lawn mower with the clear understanding that the current invention is applicable to other control cable assemblies as well as other applications like tillers, snow mobiles and many more.

FIG. 1 shows an exploded view of lever shifter control cable assembly for a throttle lever shifter and a choke lever shifter.

FIG. 2 shows child parts of a roller-spring-sleeve unit according to one embodiment of the invention.

FIG. 3 shows exploded of view of a wave spring to eliminate a friction bend in the cable assembly.

### DETAILED DESCRIPTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention provides an assembly for lever shifter cable control assembly having a choke return and a force enhancing mechanism. The assembly includes a casing having two halves defining a chamber, wherein the two halves are first housing and second housing. The first housing comprises of a first lever shifter movably mounted between the two halves of the casing for pivotal movement about a pivot axis, wherein the first lever shifter configured for to and fro movement. The second housing comprises of a second lever shifter with a torsion spring having two ends, wherein the one end of torsion spring is designed to hook to the second housing and the other end of torsion spring is designed to hook against the stiffing wall of the second lever shifter. The second lever shifter radially spins when a thumb force is applied and returns back to the desired position due to action of the torsion spring. The second housing is further attached with a wave spring to impart the lever force and to eliminate a friction bend in the cable assembly.

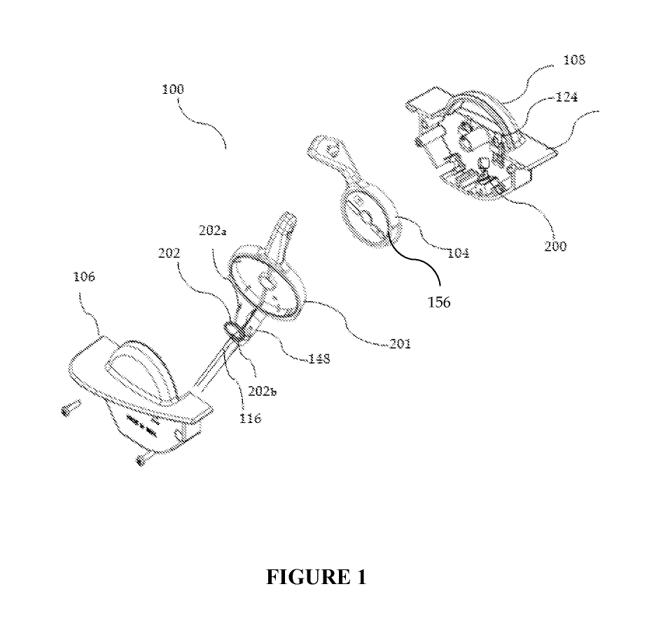

FIG. 1 shows an exploded view of a lever shifter control cable assembly with choke return mechanism. The assembly includes a casing which comprises of two halves defining a chamber there between. The two halves are first housing 108 and second housing 106. The first housing 108 comprises of a first lever shifter 104 movably mounted between the two halves of the casing for pivotal movement about a pivot axis, wherein the first lever shifter 104 configured for to and fro movement. The second housing 106 comprises of a second lever shifter 201 with a torsion spring 202 having two ends 202a and 202b. The one end 202a of torsion spring is designed to hook to the second housing 106 and the other end 202b of torsion spring is designed to hook against the stiffing wall of the second lever shifter 201. The second lever shifter 201 radially spins when a thumb force is applied and returns back to the desired position due to action of the torsion spring 202. A roller-spring-sleeve unit 200 operatively connected to the first lever shifter 104, wherein the roller-spring-sleeve unit housed in a receptacle in the casing for controlling the first lever shifter 104.

The present invention assembly further comprises of a snap fit unit 124, wherein the snap fit unit 124 comprising a flat spring configured into a U shaped nylon molded part to provide a snug fit for the casing. An at least one cable assembly 116 is mounted on an abutment lever 148. The abutment lever 148 is housed within the casing and coupled to the first lever shifter 104 and second lever shifter 201. The control cable 116 is connected to the casing through the abutment lever through a hole in the casing. The control cable 116 may be a Bowden cable. The first lever shifter 104 and the second lever shifter 201 movably mounted between the two halves of the casing pivots on a cylindrical projection and radially spins with respect to an inner wall of the casing.

The case having an inner wall which includes the first lever shifter 104, the second lever shifter 201, the roller-spring-sleeve unit 200 and the snap fit unit 124 which are configured to the inner wall. The first lever shifter 104 further comprises a groove, wherein upon operating the first lever shifter 104 the roller-spring-sleeve unit 200 rides against a wall of the first lever shifter and the roller engages with the groove. The first lever shifter 104 when operated the roller-spring-sleeve mechanism unit 200 disengages from the groove and rides on the wall of lever shifter until stopping against a boundary of the wall.

The torsion spring 202 is composed of a spring steel material. The first lever shifter 104 and the second lever shifter 201 are made of different colors such as are black, white, red, blue etc.

The first lever shifter 104 is throttle lever shifter and the second lever shifter 201 is choke lever shifter. Thus, the cable assembly 100 with the three major portions such as the lever shifter throttle 104, the cover 106, the cover 108 along with the roller-spring-sleeve unit 200 and the snap fit unit 124 provides a reliable shifter function in applications such as lawn mower.

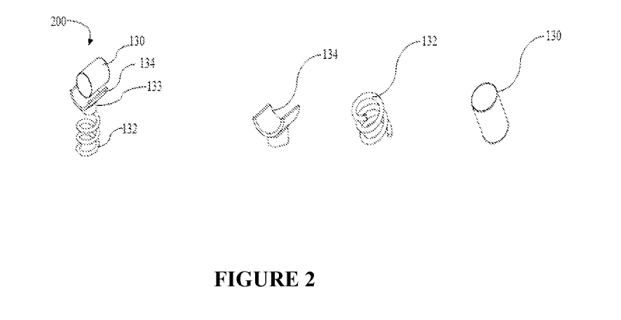

FIG. 2 shows child parts of the roller-spring-sleeve unit 200 according to an embodiment. The roller-spring-sleeve unit 200 is housed in a receptacle with a lug 131. The lug 131 engages the inner diameter of the spring 132 and enables the spring 132 to stay in the position vertically at all times. The spring 132 receives the sleeve 134. The sleeve 134 may have a dish shape and matched into a pocket. The sleeve 134 may be injection molded and composed of a nylon resin material. The sleeve 134 serves the purpose of reducing noise, vibration and harshness. The sleeve 134 receives the roller 130 wherein the roller-spring-sleeve unit 200 is consistently engaged against the lever shifter throttle 104 by a predetermined force comfortable enough for the lever shifter throttle 104 to operate by a person. The roller 130 is composed of high chromium steel and hardened. The roller-spring-sleeve unit 200 rides against the wall of the lever shifter throttle 104 smoothly through the roller 130 and engages with the groove 156 provided on the lever shifter throttle 104 at a middle distance radially to accommodate the roller 130 with a “click sound” ‘audible to confirm the engagement’. The roller-spring-sleeve unit 200 on a gentle push of the lever further, disengages from the groove 156 and starts to ride on the wall of the lever shifter throttle 104 until it dead-stops against the boundary of the wall.

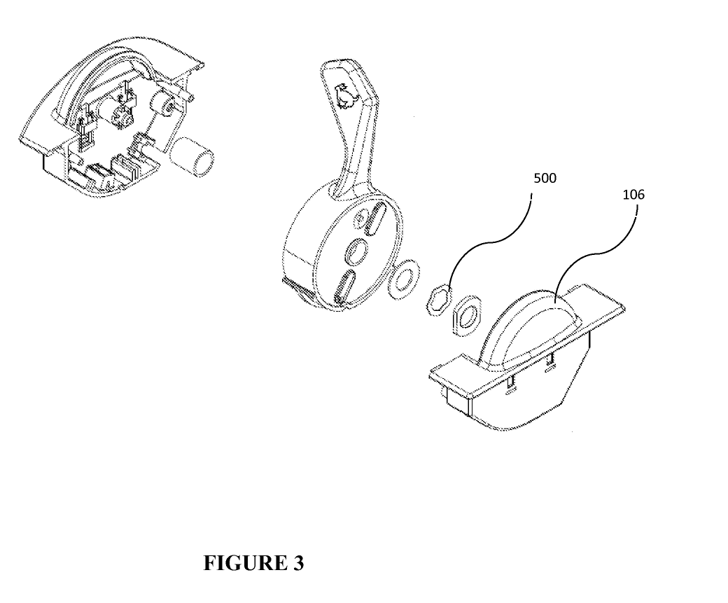

FIG. 3 shows exploded of view of the introduction of a wave spring 500 to eliminate a friction bend in the cable assembly. The second housing 106 further comprises of a wave spring 500. The wave spring 500 attached to the second housing 106 aims to impart the lever force and to eliminate a friction bend in the cable assembly.

The present invention provides ease of assembly on to the panel and reliability of the shifter function to the engine very efficiently in applications like lawn mower, snow mobiles, tiller & others.

Although preferred forms of the invention have been described above, it is to be recognized that such disclosure is by way of illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intention to rely on the Doctrine of Equivalents to determine and assess the reasonably fair scope of their invention as pertains to any apparatus not materially departing from but outside the literal scope of the invention as set out in the following claims.

We claim:

1. An assembly for choke lever shifter cable control assembly having a choke return and a force enhancing mechanism, wherein the assembly comprising:
a. a casing comprising of two halves defining a chamber there between, wherein the two halves are first housing and second housing;
b. the first housing comprises of a first lever shifter movably mounted between the two halves of the casing for pivotal movement about a pivot axis, wherein the first lever shifter configured for to and fro movement;
c. the second housing comprises of a second lever shifter with a torsion spring having two ends, wherein the one end of torsion spring is designed to hook to the second housing and the other end of torsion spring is designed to hook against the stiffing wall of the second lever shifter;
d. the second lever shifter radially spins when a thumb force is applied and returns back to the desired position due to action of the torsion spring;
e. a roller-spring-sleeve unit operatively connected to the first lever shifter, the roller-spring-sleeve unit housed in a receptacle in the casing for controlling the first lever shifter;
f. a snap fit unit comprising a flat spring configured into a U shaped nylon molded part to provide a snug fit for the casing;
a. an at least one cable assembly is mounted on an abutment lever, wherein the abutment lever is housed within the casing and coupled to the first lever shifter and second lever shifter; and
g. a control cable connected to the casing through the abutment lever through a hole in the casing.

2. The assembly as claimed in claim 1, wherein the first lever shifter and the second lever shifter movably mounted between the two halves of the casing pivots on a cylindrical projection and radially spins with respect to an inner wall of the casing.

3. The assembly as claimed in claim 1, wherein the case has an inner wall, wherein the first lever shifter, the second lever shifter, the roller-spring-sleeve unit and the snap fit unit are configured to the inner wall.

4. The assembly as claimed in claim 1, wherein the torsion spring is composed of a spring steel material.

5. The assembly as claimed in claim 1, wherein the first lever shifter and the second lever shifter are made of different colors.

6. The assembly as claimed in claim 1, wherein the first lever shifter when operated the roller-spring-sleeve mechanism unit disengages from the groove and rides on the wall of lever shifter until stopping against a boundary of the wall.

7. The assembly as claimed in claim 1, wherein the first lever shifter further comprises a groove, wherein upon operating the first lever shifter the roller-spring-sleeve unit rides against a wall of the first lever shifter and the roller engages with the groove.

8. The assembly as claimed in claim 1, wherein the roller-spring-sleeve unit is connected to a lug coupled to an inner wall of the casing, the roller-spring-sleeve unit comprises:
a compression spring coupled to the lug and positioned in a vertical orientation;
a sleeve connected to the compression spring, wherein the sleeve has a dish shaped configuration and configured to match with the lug; and
a roller configured to be received by the sleeve.

9. The second housing as claimed in claim 1, wherein the second housing further comprises of an at least one wave spring, wherein the wave spring attached to the second housing aims to impart the lever force and to eliminate a friction bend in the cable assembly.

10. The assembly as claimed in claim 1, wherein the first lever shifter is throttle lever shifter and the second lever shifter is choke lever shifter.
